(19) United States
(12) Patent Application Publication
(10) Pub. No.: US 2026/0307142 A1
(43) Pub. Date: Oct. 8, 2026

(54) COMPOSITE COPPER PARTICLES, METHOD FOR PRODUCING SAME, AND USE OF SAME

(71) Applicant: ISHIHARA SANGYO KAISHA, LTD., Osaka (JP)

(72) Inventors: Hironori KATO, Osaka (JP); Masayoshi UTSUNOMIYA, Osaka (JP)

(21) Appl. No.: 19/484,011

(22) PCT Filed: Jul. 16, 2024
(86) PCT No.: PCT/JP2024/025533

§ 371 Date: Nov. 13, 2025

(30) Foreign Application Priority Data
Jul. 18, 2023 (JP) 2023-116916

(51) Int. Cl. B22F 1/102; B22F 1/054; B22F 1/107

(52) U.S. Cl. CPC B22F 1/102; B22F 1/056; B22F 1/107; B22F 2301/10; B22F 2304/056; B22F 2304/058

(57) ABSTRACT

The present invention provides: composite copper particles which are suitable as a starting material for a paste that can be sintered even in an inert atmosphere and can be applied to a pressureless bonding method and for a bonding member that contains the paste; and a method for producing the composite copper particles.

The present invention provides composite copper particles which contain copper particles, a monocarboxylic acid or a salt thereof, and a compound represented by general formula 1: R¹(OCH₂CH₂)ₙOR². (In the formula, R¹ represents an alkyl group, an aryl group or a hydrogen atom; R² represents an alkyl group, an aryl group, a hydrogen atom or an acetyl group; and n represents an integer of 1 to 4. However, the cases where both R¹ and R² are hydrogen atoms are excluded.) The composite copper particles have an average particle diameter of 170 nm to 600 nm inclusive as measured by a scanning electron microscope.

### TECHNICAL FIELD

The present invention relates to composite copper particles, a method for producing the same, a copper paste comprising the composite copper particles, and a bonding material comprising the paste.

### BACKGROUND ART

When a semiconductor device is produced, a high-melting-point lead solder is used to bond a semiconductor element and a lead frame or the like. In recent years, among semiconductor devices, in the bonding of a power semiconductor operated at a high temperature of 150° C. or higher, a large-scale integration (LSI), or the like, the operating temperature of a semiconductor has risen close to the melting point of a high-melting-point lead solder due to an increase in capacity and space saving of the semiconductor element. In addition, with the reinforcement of Restriction of Hazardous Substances (RoHS) regulations, a lead-free bonding material is required.

Examples of such a bonding material comprise a paste comprising metal particles such as copper, silver, or the like. However, silver has disadvantages including its high price as a precious metal and the problem of migration (specifically, silver migration), thereby limiting its range of applications. Therefore, copper has been studied as the metal particles that are appropriately used for the paste.

For example, Patent Literature 1 describes a composite particle comprising a copper core particle, a plurality of aliphatic carboxylic acid molecules adsorbed on the surface of the above-mentioned copper core particle at a density of 2.5 to 5.2 molecules per 1 nm², and a plurality of polar organic small molecules having a hydrophilic group and a hydrophobic group and interacting with the above-mentioned plurality of aliphatic carboxylic acid molecules. In addition, in Example 1 thereof, a copper paste is described, which is produced by blending, dispersing, and kneading the following: the coated copper particles having an average primary particle diameter of 90.4 nm obtained in Production Example 2; the first copper powder having an average particle diameter of 2.0 μm; the second copper powder having an average particle diameter of 0.8 μm; the high molecular weight polymer dispersant; the high molecular weight polymer thickener; the lauric acid 3-propanolamide, which is an acid amide compound used as a polar organic small molecule; and the medium. Regarding this, in Patent Literature 1, it is considered that in the copper paste, composite particles are produced, in which a plurality of acid amide compound molecules interacting with a plurality of aliphatic carboxylic acid molecules are arranged around the coated copper particles, each of which comprises a copper core particle whose surface is coated with a plurality of aliphatic carboxylic acid molecules.

In addition, Patent Literature 2 describes a copper powder having an average primary particle diameter of 0.1 μm or more and 0.6 μm or less, in which the surfaces of the particles constituting the copper powder are treated with an organic surface treatment agent, and the proportion of the organic surface treatment agent in the particles in the state where the organic surface treatment agent is applied is 0.25 mass % or more and 5.50 mass % or less in terms of carbon atoms. Also, in the Examples thereof an organic surface-treated coated copper powder that has an average primary particle diameter of 150 nm to 165 nm and is treated with a specific fatty acid or aliphatic amine is described.

Furthermore, Patent Literature 3 describes a method for producing copper particles for use in bonding, the method comprising the following steps: a step of mixing a copper compound, an amine compound, and a reductant in an organic solvent to obtain a copper particle dispersion; and a step of washing the copper particle dispersion obtained in the mixing step with a solvent and separating copper particles from the copper particle dispersion by solid-liquid separation, in which the washing step is performed in a closed system. In addition, Synthesis Example 1 thereof describes a method for producing copper particles by the following steps: adding hydrazine monohydrate dropwise to a copper precursor solution obtained by mixing copper (II) acetate hydrate and a nonanoic acid hexylamine salt in an organic solvent; and subjecting the mixture to solvent substitution with diethylene glycol in a closed system. Also, Patent Literature 3 describes a concentrate comprising copper particles having an average particle diameter of 50 nm produced by the method for producing copper particles for use in bonding.

### CITATION LIST

### Patent Literature

Patent Literature 1: JP 2020-090725 A
Patent Literature 2: JP 2015-168878 A
Patent Literature 3: JP 2020-035978 A

### SUMMARY OF INVENTION

### Technical Problem

In semiconductor bonding, there are the following methods: a method (i.e., a pressure bonding method) in which metal particles comprised in a bonding material are sintered to achieve bonding by heating a laminate obtained by laminating a base material and the material to be bonded with the bonding material interposed therebetween while applying a load, and a method (i.e., a pressureless bonding method) in which metal particles comprised in a bonding material are sintered to achieve bonding only by heating without applying a load.

Among them, the pressureless bonding method does not require the application of pressure to a material to be bonded at the time of bonding, and thus an improvement in production efficiency can be expected. In addition, at the time of bonding of a material to be bonded (for example, a semiconductor), damage to the material to be bonded can be minimized. However, there is a problem that a sufficient bonding strength cannot be obtained in the pressureless bonding method. Therefore, a bonding material capable of producing a sintered body having a sufficient bonding strength by the pressureless bonding method is being required.

In addition, copper particles are metal particles that easily form an oxide film on their surfaces, and thus are metal particles difficult to achieve a sufficient bonding strength. Therefore, when a bonding material using copper particles is sintered, sintering in a reducing atmosphere has been required from the viewpoint of removing the surface oxide film of the copper particles. However, sintering in a reducing atmosphere requires a new cost such as introduction of a dedicated facility, and thus a bonding material that can be sintered in an inert atmosphere and is capable of obtaining a sufficient bonding strength is being required.

In Patent Literature 1, from an SEM cross-sectional photograph of a laminated body obtained by pressure sintering, under conditions of 350° C. and 30 MPa, a copper paste composition prepared by blending two copper powders having different average particle diameters, a polymer thickener, a polar organic small molecule, and a medium with coated copper particles produced, it is observed that a dense and highly uniform copper bonding layer can be obtained. However, in this case, a pressure sintering (i.e., a pressure bonding method) involving the above-mentioned problem came to be used. Furthermore, the force for bonding the materials together, that is, the bonding strength, has not been examined. In addition, it has not been examined whether this can be appropriately used in a pressureless bonding method.

Although Patent Literature 2 describes copper particles having low-temperature sinterability, it only measures the sintering start temperature of the copper particles in a hydrogen-containing atmosphere by means of a thermal analysis apparatus, and does not examine the bonding strength when these copper particles are used for a bonding material. In addition, it has not examined whether these copper particles can be appropriately used in sintering in an inert atmosphere or in pressureless bonding. In this regard, considering that in examples, a pellet is produced by pressure molding the produced copper powder at 1.0 MPa and sintering (i.e., firing) of the pellet is initiated, it is normally understood that in Patent Literature 2, even when the produced copper powder is used for a bonding material, a method (i.e., a pressure bonding method) is applied in which the metal particles as the copper powder are similarly pressurized (i.e., loaded) to produce the pellet, and a base material and a material to be bonded are sintered under pressure via the pellet. Further, in the examples of Patent Literature 2, copper particles having an average primary particle diameter of 150 nm to 165 nm are described, and it is normally understood that the copper particles do not achieve a sufficient bonding strength.

Patent Literature 3 describes that the bonding strength is 35 to 40 MPa when a bonding paste, obtained by kneading produced copper particles and an organic solvent, is cured under pressureless conditions at 200° C. for 60 minutes in a nitrogen-3% hydrogen atmosphere. However, the bonding paste described thereof is sintered in a reducing atmosphere containing hydrogen, and this causes a problem of increased cost burden related to equipment.

The present invention has been made in view of the above-mentioned problems, and an object of the present invention is to provide a paste exhibiting a sufficient bonding strength even in pressureless bonding in an inert atmosphere, and is to provide composite copper particles suitable as a raw material of a bonding material comprising the paste.

### Solution to Problem

Therefore, the present inventors have extensively conducted studies, and have found a significant effect by setting the average particle diameter of copper particles to a specific range and treating the surfaces thereof with a specific organic species. As a result, the present inventors have found the following: a paste capable of bonding a base material and a material to be bonded with a desired bonding strength in an inert atmosphere and under pressureless bonding, composite copper particles capable of being appropriately used for a bonding material comprising the paste, and a method for simply producing the same; and a paste comprising the composite copper particles and a bonding material comprising the paste, and thus have completed the present invention.

That is, the present invention provides the following:
(1) Composite copper particles comprising:
copper particles;
a monocarboxylic acid or a salt thereof; and
a compound represented by general formula 1: R¹(OCH₂CH₂)ₙOR² (wherein R¹ represents an alkyl group, an aryl group, or a hydrogen atom; R² represents an alkyl group, an aryl group, a hydrogen atom, or an acetyl group; and n is an integer of 1 or more and 4 or less; provided that R¹ and R² are not both hydrogen atoms),
wherein an average particle diameter measured by means of a scanning electron microscope is 170 nm or more and 600 nm or less;
(2) The composite copper particles according to (1) comprising the monocarboxylic acid or the salt thereof in an amount of 5.3 molecules or more and 50.0 molecules or less with respect to 1 nm² of a surface area of the copper particles;
(3) The composite copper particles according to (1) or (2), wherein the monocarboxylic acid or the salt thereof has 2 or more and 12 or less carbon atoms;
(4) The composite copper particles according to any one of (1) to (3), wherein the monocarboxylic acid or the salt thereof is at least one carboxylic acid selected from the group consisting of caprylic acid, capric acid, and 2-ethylcaproic acid, or a salt thereof;
(5) The composite copper particles according to any one of (1) to (4), wherein the monocarboxylic acid or the salt thereof is at least one carboxylic acid selected from the group consisting of caprylic acid and capric acid, or a salt thereof;
(6) The composite copper particles according to any one of (1) to (5), wherein a molecular weight of the compound represented by general formula 1 is 100 or more and 400 or less;
(7) The composite copper particles according to any one of (1) to (6), wherein the compound represented by general formula 1 is diethylene glycol monohexyl ether or diethylene glycol monobutyl ether;
(8) The composite copper particles according to any one of (1) to (7), wherein a content of the compound represented by general formula 1 is 0.1 mass % or more and 2.0 mass % or less with respect to a total mass of the composite copper particles;
(9) The composite copper particles according to any one of (1) to (8), wherein a total mass of the monocarboxylic acid or the salt thereof and the compound represented by general formula 1 is 0.3 mass % or more and 3.5 mass % or less with respect to a total mass of the composite copper particles;
(10) A method for producing composite copper particles having an average particle diameter of 170 nm or more and 600 nm or less measured by means of a scanning electron microscope, the method comprising a step of mixing copper particles, a monocarboxylic acid or a salt thereof, a compound represented by general formula 1: R¹(OCH₂CH₂)ₙOR² (wherein R¹ represents an alkyl group, an aryl group, or a hydrogen atom; R² represents an alkyl group, an aryl group, a hydrogen atom, or an acetyl group; and n is an integer of 1 or more and 4 or less; provided that R¹ and R² are not both hydrogen atoms), and a solvent;
(11) The method according to (10), wherein the monocarboxylic acid or the salt thereof has 2 or more and 12 or less carbon atoms;
(12) The method according to (10) or (11), wherein the monocarboxylic acid or the salt thereof is at least one carboxylic acid selected from the group consisting of caprylic acid, capric acid, and 2-ethylcaproic acid, or a salt thereof;
(13) The method according to any one of (10) to (12), wherein the monocarboxylic acid or the salt thereof is at least one carboxylic acid selected from the group consisting of caprylic acid and capric acid, or a salt thereof;
(14) The method according to any one of (10) to (13), wherein a molecular weight of the compound represented by general formula 1 is 100 or more and 400 or less;
(15) The method according to any one of (10) to (14), wherein the compound represented by general formula 1 is diethylene glycol monohexyl ether or diethylene glycol monobutyl ether;
(16) The method according to any one of (10) to (15), wherein the monocarboxylic acid or the salt thereof is mixed in an amount of 1 mass % or more and 30 mass % or less with respect to the solvent;
(17) The method according to any one of (10) to (16) comprising the monocarboxylic acid or the salt thereof in the solvent in an amount of 1 mass % or more and 30 mass % or less with respect to the solvent;
(18) The method according to any one of (10) to (17), wherein the compound represented by general formula 1 is mixed in an amount of 1 mass % or more and 30 mass % or less with respect to the solvent;
(19) The method according to any one of (10) to (18) comprising the compound represented by general formula 1 in the solvent in an amount of 1 mass % or more and 30 mass % or less with respect to the solvent;
(20) The method according to any one of (10) to (19), wherein the monocarboxylic acid or the salt thereof and the compound represented by general formula 1 are mixed in a total mass of 2 mass % or more and 35 mass % or less with respect to the solvent;
(21) The method according to any one of (10) to (20) comprising the monocarboxylic acid or the salt thereof and the compound represented by general formula 1 in the solvent in a total mass of 2 mass % or more and 35 mass % or less with respect to the solvent;
(22) A copper paste comprising the composite copper particles according to any one of (1) to (9) and a paste solvent;
(23) A bonding material comprising the copper paste according to (22);
and the like.

### Advantageous Effects of Invention

According to the composite copper particles of the present invention, a copper paste comprising the composite copper particles is sintered even in an inert atmosphere, and can be appropriately used for a bonding material in a pressureless bonding method. Therefore, a paste comprising the composite copper particles of the present invention and a bonding material comprising the paste can bond a base material and a material to be bonded by a pressureless bonding method even in an inert atmosphere, and a sintered body produced thereby has an excellent bonding strength.

### BRIEF DESCRIPTION OF DRAWINGS

FIG. 1 shows a scanning electron micrograph of sample 1.

FIG. 2 shows a scanning electron micrograph of sample 6.

FIG. 3 shows a scanning electron micrograph of sample 7.

### DESCRIPTION OF EMBODIMENTS

### <Composite Copper Particles>

The composite copper particles of the present invention comprise copper particles, a monocarboxylic acid or a salt thereof, and a compound represented by general formula 1: R¹(OCH₂CH₂)ₙOR² (wherein R¹ represents an alkyl group, an aryl group, or a hydrogen atom; R² represents an alkyl group, an aryl group, a hydrogen atom, or an acetyl group; and n is an integer of 1 or more and 4 or less; provided that R¹ and R² are not both hydrogen atoms).

The composite copper particles of the present invention have an average particle diameter of 170 nm or more and 600 nm or less, preferably 180 nm or more and 500 nm or less, and more preferably 200 nm or more and 400 nm or less. By setting the average particle diameter of the composite copper particles to the above-mentioned range, the formation of an oxide film (i.e., copper oxide) can be reduced. Because the average particle diameter of the composite copper particles is employed in the above-mentioned range, the dispersibility of the composite copper particles in a paste is improved when the composite copper particles are used for a bonding material. Furthermore, by employing the above-mentioned average particle diameter of the composite copper particles, the bonding strength of a paste comprising the composite copper particles and the bonding strength of a bonding material comprising the paste can be improved.

The above-mentioned average particle diameter of the composite copper particles is measured as follows. The composite copper particles of the present invention are photographed by means of a scanning electron microscope (S4800 manufactured by Hitachi High-Technologies Corporation; hereinafter also referred to as “SEM”), the maximum Feret diameter (which is, hereinafter, simply referred to as “Feret diameter”) of each of 50 primary particles in the SEM visual field is measured, and the arithmetic average value thereof is taken as the average particle diameter.

### <Copper Particles>

The composite copper particles of the present invention comprise copper particles. The average particle diameter of the above-mentioned copper particles is preferably 170 nm or more and 600 nm or less, more preferably 180 nm or more and 500 nm or less, and still more preferably 200 nm or more and 400 nm or less. By setting the average particle diameter of the above-mentioned copper particles to such a range, the composite copper particles of the present invention can achieve a desired average particle diameter. The above-mentioned copper particles may be commercially available copper particles that are purchased and used, may be produced by a known method, or may also be produced by a method mentioned later.

The average particle diameter of the above-mentioned copper particles can be measured in the same manner as the average particle diameter of the above-mentioned composite copper particles.

In addition, in the composite copper particles, since an increase in the average particle diameter caused by comprising a monocarboxylic acid or a salt thereof and a compound represented by the above-mentioned general formula 1 is very small, it can be regarded in the present application that the average particle diameter of the copper particles is not changed by the above-mentioned monocarboxylic acid and the compound represented by the above-mentioned general formula 1.

The above-mentioned shape of the copper particles is not particularly limited, and those in any shape such as an irregular shape, a spherical shape, a polyhedron, a spindle shape, and a plate shape can be used.

The above-mentioned copper particles may comprise a substance other than metallic copper, such as a raw material or a reactant used in the production process, to such an extent that no problem is caused according to its use.

### <Monocarboxylic Acid or Salt Thereof>

The composite copper particles of the present invention comprise a monocarboxylic acid or a salt thereof. The above-mentioned monocarboxylic acid species are not particularly limited. The hydrocarbon group in a monocarboxylic acid molecule may be formed only of a single bond or may be formed of one or more multiple bonds in the middle. In addition, a hydrocarbon group moiety in the monocarboxylic acid molecule may be linear, may comprise a branch in the middle, or may comprise a cyclic structure in the middle or at the end. In addition, a heteroatom may be comprised at any position in the monocarboxylic acid molecule.

Examples of the monocarboxylic acid comprise formic acid, acetic acid, propionic acid, butyric acid, valeric acid, caproic acid, caprylic acid, enanthic acid, pelargonic acid, capric acid, lauric acid, oleic acid, stearic acid, isostearic acid, 2-ethylcaproic acid, and isopalmitic acid and so on. Examples of the salt of monocarboxylic acid comprise an alkali metal salt such as a sodium salt or a potassium salt, an alkaline earth metal salt such as a magnesium salt or a calcium salt, an ammonium salt, and an amine salt.

The above-mentioned monocarboxylic acid or a salt thereof may be comprised in the composite copper particles as only one species or as two or more species. In particular, it is preferable to comprise a monocarboxylic acid having 2 or more and 12 or less carbon atoms in one molecule comprising a carboxyl group or a salt thereof, and in particular, it is more preferable to comprise caprylic acid, capric acid, or 2-ethylcaproic acid. The composite copper particles comprising the above-mentioned monocarboxylic acid or a salt thereof is preferable because the bonding strength of the paste comprising the composite copper particles of the present invention and the bonding strength of the bonding material comprising the paste are improved.

The above-mentioned monocarboxylic acid or a salt thereof is preferably comprised in the composite copper particles in an amount of 5.3 molecules or more with respect to 1 nm² of the surface area of the copper particles.

In one embodiment of the composite copper particles of the present invention, the above-mentioned monocarboxylic acid or a salt thereof may be present on the surface of the copper particles in an amount of 5.3 molecules or more with respect to 1 nm² of the surface area of the copper particles. A specific embodiment as such an invention embodiment is understood as an embodiment in which the monocarboxylic acid or the salt thereof forms a cumulative film (i.e., film in which monomolecular films are stacked) on the surface of the copper particles.

The molecular density of the monocarboxylic acid or a salt thereof in the region in which an agglomeration film is formed in the liquid is 2.5 molecules or more and 5.2 molecules or less with respect to 1 nm² of the surface area of the copper particles, and a specific embodiment in this case is understood as an embodiment in which the monocarboxylic acid or a salt thereof forms a monomolecular film on the surface of the copper particles.

On the other hand, in the above-mentioned one embodiment of the composite copper particles of the present invention, since the monocarboxylic acid or a salt thereof is comprised in an amount of 5.3 molecules or more with respect to 1 nm² of the surface area of the copper particles, as mentioned above, the monocarboxylic acid or a salt thereof is further bonded on the monomolecular film of the monocarboxylic acid on the surface of the copper particles to form a cumulative film, so that the formation of an oxide film (i.e., copper oxide) of the composite copper particle can be preferably reduced. In addition, when the paste comprising the composite copper particles and the bonding material comprising the paste are used, the bonding strength of the bonding material is preferably improved.

The molecular density of the monocarboxylic acid or a salt thereof with respect to 1 nm² of the surface area of the copper particles is preferably 5.3 molecules or more with respect to 1 nm² of the surface area of the copper particles. By setting the above-mentioned molecular density to the above-mentioned range, the formation of an oxide film (i.e., copper oxide) can be reduced, and the bonding strength of the paste comprising the composite copper particles of the present invention and the bonding strength of the bonding material comprising the paste are preferably improved. In addition, the upper limit value of the above-mentioned molecular density is sufficient when set to 50.0 molecules or less with respect to 1 nm² of the surface area of the copper particles, from the viewpoint that further improvement in the effect of reducing the formation of an oxide film (i.e., copper oxide) is not expected.

Hereinafter, the number of molecules of the monocarboxylic acid or a salt thereof with respect to 1 nm² of the surface area of the copper particles is referred to as a molecular density, and is calculated as follows.

In the composite copper particles, the identification and content of the component of the monocarboxylic acid or a salt thereof (which is, hereinafter, also referred to as monocarboxylic acid component) are measured by means of gas chromatography as follows. When two or more monocarboxylic acids or salts thereof are used in combination, the total amount thereof is defined as the content of the monocarboxylic acid component. From the viewpoint of measurement accuracy, when the content of the above-mentioned monocarboxylic acid component is 0.03 mass % or less with respect to the total mass of the composite copper particles, it is regarded that the monocarboxylic acid component is not comprised in the composite copper particles.

A gas chromatograph-mass spectrometer equipped with a pyrolysis apparatus is used for gas chromatography. As the pyrolysis apparatus, for example, Multi-Shot Pyrolyzer MODEL EGA/PY-3030D (manufactured by Frontier Laboratories Ltd.) can be used, and as the gas chromatograph-mass spectrometer, for example, Nexis GC-2030 (manufactured by Shimadzu Corporation) can be used.

The number of molecules of the monocarboxylic acid component comprised in 1 g of the composite copper particles is represented by the following formula (a).

$$[ Number of molecules of monocarboxylic acid component ] = {M}_{acid} / ( {M}_{w} / {N}_{A} ) \qquad ( a )$$

Here, M_{acid} is the content (g) of the monocarboxylic acid or a salt thereof comprised in 1 g of the composite copper particles, M_{w} is the molecular weight (g/mol) of the monocarboxylic acid component, and N_{A} is the Avogadro constant (that is, 6.02×10²³ mol⁻¹).

The molecular density (molecules/nm²) of the monocarboxylic acid component with respect to 1 nm² of the surface area of the composite copper particles is calculated by the following formula (b).

$$[ Molecular density ] = number of molecules of monocarboxylic acid component / specific surface area of copper particle \qquad ( b )$$

The specific surface area of the copper particles may be measured by means of a known specific surface area measuring apparatus, and for example, Macsorb (registered trademark) HM Model-1201 (manufactured by Mountech Co., Ltd.) can be used as such an apparatus. Regarding the measurement of the specific surface area, copper particles produced by the following procedure are used.

An operation of mixing 5 g of the composite copper particles of the present invention and 50 ml of 2-propanol and performing solid-liquid separation at a centrifugal force of 400G for 5 minutes by means of a centrifuge is repeated twice to obtain a solid content of copper particles from which the monocarboxylic acid or a salt thereof and the compound represented by the above-mentioned general formula 1 are desorbed. After the solid content of the above-mentioned copper particles is collected, the solvent is removed from the collected solid content of the copper particles by preliminary drying under vacuum, and then adsorbed moisture is removed by drying in a nitrogen atmosphere to obtain copper particles.

The content of the above-mentioned monocarboxylic acid or a salt thereof is preferably in a range of 0.2 mass % or more and 2.0 mass % or less, and more preferably in a range of 0.3 mass % or more and 1.5 mass % or less with respect to the total mass of the composite copper particles. By setting the content of the above-mentioned monocarboxylic acid or a salt thereof to the above-mentioned range, the bonding strength of the paste comprising the composite copper particles of the present invention and the bonding strength of the bonding material comprising the paste are preferably improved.

### <Compound Represented by General Formula 1>

The composite copper particles of the present invention comprise a compound represented by general formula 1: R¹(OCH₂CH₂)ₙOR² (wherein R¹ represents an alkyl group, an aryl group, or a hydrogen atom; R² represents an alkyl group, an aryl group, a hydrogen atom, or an acetyl group; and n is an integer of 1 or more and 4 or less; provided that R¹ and R² are not both hydrogen atoms).

As the compound represented by the above-mentioned general formula 1, the number of carbon atoms in R¹ is preferably 1 or more and 10 or less, and more preferably 1 or more and 6 or less. The number of carbon atoms in R² is preferably 0 or more and 10 or less, and more preferably 0 or more and 6 or less. By setting the number of carbon atoms to the above-mentioned range, the bonding strength of the paste comprising the composite copper particles of the present invention and the bonding strength of the bonding material comprising the paste are preferably improved.

Examples of the compound represented by the above-mentioned general formula 1 comprise glycol ethers. Examples of the above-mentioned glycol ethers comprise ethylene glycol monomethyl ether, diethylene glycol monomethyl ether, ethylene glycol monoethyl ether, diethylene glycol monoethyl ether, ethylene glycol monopropyl ether, diethylene glycol monopropyl ether, ethylene glycol monobutyl ether, diethylene glycol monobutyl ether, ethylene glycol monohexyl ether, diethylene glycol monohexyl ether, ethylene glycol monoethyl ether acetate, diethylene glycol monoethyl ether acetate, ethylene glycol monopropyl ether acetate, diethylene glycol monopropyl ether acetate, ethylene glycol monobutyl ether acetate, diethylene glycol monobutyl ether acetate, ethylene glycol dimethyl ether, diethylene glycol dimethyl ether, triethylene glycol dimethyl ether, tetraethylene glycol dimethyl ether, ethylene glycol diethyl ether, diethylene glycol diethyl ether, ethylene glycol dipropyl ether, diethylene glycol dipropyl ether, diethylene glycol dibutyl ether, and diethylene glycol methyl ethyl ether.

The molecular weight of the compound represented by the above-mentioned general formula 1 is preferably 100 or more and 400 or less, more preferably 100 or more and 300 or less, and still more preferably 100 or more and 200 or less. As such a compound, diethylene glycol monobutyl ether (which is, hereinafter, also referred to as DGMBE) or diethylene glycol monohexyl ether (which is, hereinafter, also referred to as DGMHE) is more preferable. When the molecular weight of the compound represented by the above-mentioned general formula 1 is set to the above-mentioned range, or the compound represented by the above-mentioned general formula 1 is DGMBE or DGMHE, the bonding strength of the paste comprising the composite copper particles of the present invention and the bonding strength of the bonding material comprising the paste are preferably improved.

In the above-mentioned composite copper particles, the identification and content of the compound represented by the above-mentioned general formula 1 can be measured by gas chromatography in the same manner as the measurement of the monocarboxylic acid or a salt thereof mentioned above.

The content of the compound represented by the above-mentioned general formula 1 in the above-mentioned composite copper particles is preferably 0.1 mass % or more and 2.0 mass % or less, and more preferably 0.1 mass % or more and 1.5 mass % or less with respect to the total mass of the composite copper particles. By setting the content of the compound represented by the above-mentioned general formula 1 in the above-mentioned composite copper particles to such a range, the bonding strength of the paste comprising the composite copper particles of the present invention and the bonding strength of the bonding material comprising the paste are preferably improved.

In the composite copper particles of the present invention, the bonding mode of each component when the monocarboxylic acid or a salt thereof and the compound represented by the above-mentioned general formula 1 form a cumulative film on the surface of the copper particles is not particularly limited, and may be, for example, an intermolecular force such as a van der Waals force, polar attraction, or hydrogen bonding, or may be physical or chemical adsorption.

When a cumulative film is formed on the surface of the above-mentioned copper particles, a compound to be bonded to the surface of the copper particles to form a monomolecular film on the surface of the copper particle is not particularly limited. Specifically, the monocarboxylic acid or a salt thereof may be bonded to the surface of the copper particles to form a monomolecular film, the compound represented by the above-mentioned general formula 1 may be bonded to the surface of the copper particles to form a monomolecular film, or both of them (i.e., the monocarboxylic acid or a salt thereof and the compound represented by the above-mentioned general formula 1) may be bonded to the surface of the copper particles to form a monomolecular film. It is understood that the above-mentioned cumulative film is formed by bonding the monocarboxylic acid or a salt thereof and the compound represented by the above-mentioned general formula 1 (not bonded to the surface of the copper particles) on the monomolecular film formed as mentioned above.

Among them, it is preferable that the monocarboxylic acid or a salt thereof is bonded to the surface of the copper particles to form a monomolecular film. In this way, the bonding strength of the paste comprising the composite copper particles of the present invention and the bonding strength of the bonding material comprising the paste are preferably improved.

In the composite copper particles of the present invention, the total content (i.e., total amount) of the monocarboxylic acid or a salt thereof and the compound represented by the above-mentioned general formula 1 is preferably 0.3 mass % or more and 3.5 mass % or less with respect to the total mass of the composite copper particles. By setting the total content of the monocarboxylic acid or a salt thereof and the compound represented by the above-mentioned general formula 1 to the above-mentioned range, the bonding strength of the paste comprising the composite copper particles of the present invention and the bonding strength of the bonding material comprising the paste are preferably improved.

### <Production of Composite Copper Particles>

A method for producing composite copper particles of the present invention will be described. The composite copper particles of the present invention can be produced by a method comprising a step of mixing copper particles, a monocarboxylic acid or a salt thereof, a compound represented by general formula 1: R¹(OCH₂CH₂)ₙOR² (wherein R¹ represents an alkyl group, an aryl group, or a hydrogen atom; R² represents an alkyl group, an aryl group, a hydrogen atom, or an acetyl group; and n is an integer of 1 or more and 4 or less; provided that R¹ and R² are not both hydrogen atoms), and a solvent.

In the method for producing composite copper particles of the present invention, the above-mentioned monocarboxylic acid or a salt thereof is not particularly limited. The hydrocarbon group in a monocarboxylic acid molecule may be formed only of a single bond or may be formed of one or more multiple bonds in the middle. In addition, a hydrocarbon group moiety in the monocarboxylic acid molecule may be linear, may comprise a branch in the middle, or may comprise a cyclic structure in the middle or at the end. In addition, a heteroatom may be present at any position in the monocarboxylic acid molecule.

Examples of the monocarboxylic acid comprise formic acid, acetic acid, propionic acid, butyric acid, valeric acid, caproic acid, caprylic acid, enanthic acid, pelargonic acid, capric acid, lauric acid, oleic acid, stearic acid, isostearic acid, 2-ethylcaproic acid, and isopalmitic acid. Examples of the salt of monocarboxylic acid comprise an alkali metal salt such as a sodium salt or a potassium salt, an alkaline earth metal salt such as a magnesium salt or a calcium salt, an ammonium salt, and an amine salt.

The above-mentioned monocarboxylic acid or a salt thereof may be only one species or two or more species thereof. In particular, it is preferable to use a monocarboxylic acid having 2 or more and 12 or less carbon atoms in one molecule comprising a carboxyl group or a salt thereof. Among these, it is more preferable to use caprylic acid, capric acid, or 2-ethylcaproic acid. The use of the above-mentioned monocarboxylic acid or a salt thereof preferably improves the bonding strength of the paste comprising the composite copper particles and the bonding strength of the bonding material comprising the paste.

In the method for producing composite copper particles of the present invention, the above-mentioned monocarboxylic acid or a salt thereof is mixed in an amount of preferably 1 mass % or more and 30 mass % or less, and more preferably 2 mass % or more and 20 mass % or less with respect to the above-mentioned solvent. Such a range is preferable because the content of the monocarboxylic acid or a salt thereof with respect to the total mass of composite copper particles efficiently falls within a desired range.

In the method for producing composite copper particles of the present invention, the above-mentioned monocarboxylic acid or a salt thereof is preferably comprised in the above-mentioned solvent in an amount of 1 mass % or more and 30 mass % or less with respect to the above-mentioned solvent. In addition, it is more preferably comprised in the above-mentioned solvent in an amount of 2 mass % or more and 20 mass % or less. Such a range is preferable because the content of the monocarboxylic acid or a salt thereof with respect to the total mass of the composite copper particles efficiently falls within a desired range. Furthermore, the solvent comprising the monocarboxylic acid or a salt thereof is preferable because the monocarboxylic acid or a salt thereof is efficiently bonded to the surface of the copper particles (or the monomolecular film formed on the surface of the copper particles) to efficiently form a cumulative film.

In the method for producing composite copper particles of the present invention, as the compound represented by general formula 1: R¹(OCH₂CH₂)ₙOR² (wherein R¹ represents an alkyl group, an aryl group, or a hydrogen atom; R² represents an alkyl group, an aryl group, a hydrogen atom, or an acetyl group; and n is an integer of 1 or more and 4 or less; provided that R¹ and R² are not both hydrogen atoms), the number of carbon atoms in R¹ is preferably 1 or more and 10 or less, and more preferably 1 or more and 6 or less. The number of carbon atoms in R² is preferably 0 or more and 10 or less, and more preferably 0 or more and 6 or less. In this way, the bonding strength of the paste comprising the composite copper particles of the present invention and the bonding strength of the bonding material comprising the paste are preferably improved.

Examples of the compound represented by the above-mentioned general formula 1 include glycol ethers. Examples of the above-mentioned glycol ethers comprise glycol ethers. Examples of the above-mentioned glycol ethers comprise ethylene glycol monomethyl ether, diethylene glycol monomethyl ether, ethylene glycol monoethyl ether, diethylene glycol monoethyl ether, ethylene glycol monopropyl ether, diethylene glycol monopropyl ether, ethylene glycol monobutyl ether, diethylene glycol monobutyl ether, ethylene glycol monohexyl ether, diethylene glycol monohexyl ether, ethylene glycol monoethyl ether acetate, diethylene glycol monoethyl ether acetate, ethylene glycol monopropyl ether acetate, diethylene glycol monopropyl ether acetate, ethylene glycol monobutyl ether acetate, diethylene glycol monobutyl ether acetate, ethylene glycol dimethyl ether, diethylene glycol dimethyl ether, triethylene glycol dimethyl ether, tetraethylene glycol dimethyl ether, ethylene glycol diethyl ether, diethylene glycol diethyl ether, ethylene glycol dipropyl ether, diethylene glycol dipropyl ether, diethylene glycol dibutyl ether, and diethylene glycol methyl ethyl ether.

The molecular weight of the compound represented by the above-mentioned general formula 1 is preferably 100 or more and 400 or less, more preferably 100 or more and 300 or less, and still more preferably 100 or more and 200 or less. As such a compound, diethylene glycol monobutyl ether (DGMBE) or diethylene glycol monohexyl ether (DGMHE) is more preferable. When the molecular weight of the compound represented by the above-mentioned general formula 1 is set to the above-mentioned range, or the compound represented by the above-mentioned general formula 1 is DGMBE or DGMHE, the bonding strength of the paste comprising the composite copper particles of the present invention and the bonding strength of the bonding material comprising the paste are preferably improved.

In the method for producing composite copper particles of the present invention, the compound represented by the above-mentioned general formula 1 is mixed in an amount of preferably 1 mass % or more and 30 mass % or less, and more preferably 2 mass % or more and 20 mass % or less with respect to the above-mentioned solvent. Such a range is preferable because the content of the compound represented by the above-mentioned general formula 1 with respect to the total mass of composite copper particles efficiently falls within a desired range.

In the method for producing composite copper particles of the present invention, the compound represented by the above-mentioned general formula 1 is preferably comprised in the above-mentioned solvent in an amount of 1 mass % or more and 30 mass % or less with respect to the above-mentioned solvent. In addition, the compound represented by the above-mentioned general formula 1 is more preferably comprised in the above-mentioned solvent in an amount of 2 mass % or more and 20 mass % or less. Such a range is preferable because the content of the compound represented by the above-mentioned general formula 1 with respect to the total mass of composite copper particles falls within a desired range. Furthermore, the solvent comprising the compound represented by the above-mentioned general formula 1 is preferable because the compound represented by the above-mentioned general formula 1 is efficiently bonded to the surface of the copper particles (or the monomolecular film formed on the surface of the copper particles) to efficiently form a cumulative film.

In the method for producing composite copper particles of the present invention, the total mass of the above-mentioned monocarboxylic acid or a salt thereof and the compound represented by the above-mentioned general formula 1 is preferably 2 mass % or more and 35 mass % or less with respect to the above-mentioned solvent. By setting the total mass of the above-mentioned monocarboxylic acid or a salt thereof and the compound represented by the above-mentioned general formula 1 to the above-mentioned range, excessive content of the organic component can be avoided, thereby reducing the burden of the drying step.

In the method for producing composite copper particles of the present invention, the above-mentioned monocarboxylic acid or a salt thereof and the compound represented by the above-mentioned general formula 1 is preferably comprised in the above-mentioned solvent in the total mass of 2 mass % or more and 35 mass % or less with respect to the above-mentioned solvent. By setting the total mass of the above-mentioned monocarboxylic acid or a salt thereof and the compound represented by the above-mentioned general formula 1 comprised in the above-mentioned solvent to the above-mentioned range, the burden of the drying step due to excessive content of an organic component can be reduced. Furthermore, the solvent comprising the carboxylic acid or a salt thereof and the compound represented by the above-mentioned general formula 1 is preferable because a cumulative film is efficiently formed by efficiently bonding to the surface of the copper particles (or the monomolecular film formed on the surface of the copper particles).

In the method for producing composite copper particles of the present invention, the above-mentioned solvent is not particularly limited as long as it does not interact with the above-mentioned monocarboxylic acid or a salt thereof or the compound represented by the above-mentioned general formula 1. As such a solvent, for example, methanol, ethanol, 1-propanol, 2-propanol, acetone, methyl ethyl ketone, or the like can be used.

The mixing order of each of the above-mentioned raw materials is not particularly limited. For example, all the raw materials may be mixed at once, or the solvent and other raw materials may be mixed one by one in an arbitrary order. In addition, the solution obtained by mixing a solvent and at least one raw material may be prepared, and the solution may be mixed in an arbitrary order. Specifically, it is preferable to prepare a treatment solution in which a solvent, the monocarboxylic acid or a salt thereof, and the compound represented by the above-mentioned general formula 1 are mixed, and to mix the above-mentioned treatment solution with copper particles, and it is more preferable to mix a dispersion comprising copper particles obtained by mixing the solvent and copper particles, with a treatment solution in which the solvent, the monocarboxylic acid or a salt thereof, and the compound represented by the above-mentioned general formula 1 are mixed. This is preferable because the monocarboxylic acid or a salt thereof and the compound represented by the above-mentioned general formula 1 are efficiently bonded to the surface of the copper particles (or the monomolecular film formed on the surface of the copper particles) to efficiently form a cumulative film.

In the above-mentioned mixing, stirring may be performed by means of a known stirrer, and as such a stirrer, for example, a blade-type stirrer, a disperser mixer, a homomixer, or the like can be used. The mixing time is not particularly limited, but may be 5 minutes or longer. With this mixing time, each of the above-mentioned raw materials can be sufficiently mixed. Furthermore, the rotation speed is also not particularly limited as long as it is 100 rpm or more, and each of the above-mentioned raw materials can be sufficiently mixed at this rotation speed.

The composite copper particles obtained in this step may be subjected to solid-liquid separation as necessary. In solid-liquid separation, a known filtration method can be used, and for example, a pressure filtration device such as a rotary press or a filter press usually used industrially, or a vacuum filtration device such as a Nutsche filter or a Moore filter can be used. Centrifugation or the like can also be used.

In the above-mentioned solid-liquid separation, the solid content may be washed by a known method.

Further, a step of drying the solid content obtained by the solid-liquid separation may be comprised. When the drying step is comprised, the drying temperature, the drying time, and the drying atmosphere can be appropriately set. For example, the drying temperature is preferably 20° C. or higher and 120° C. or lower, the drying time is preferably 0.5 hours or more and 10 hours or less, and the drying atmosphere is preferably a vacuum atmosphere.

In the drying step, for example, a heating device such as a dryer, an oven, or an electric furnace, a desiccator controlled to a predetermined temperature, a vacuum dryer, a decompression dryer, or the like can be used.

When a desiccator is used in the drying step, the above-mentioned solid content can be dried by controlling the inside of the desiccator to a predetermined temperature and creating a vacuum atmosphere. When the inside of the desiccator is brought into a vacuum atmosphere, a vacuum pump may be used. As the vacuum pump, for example, G-20DA manufactured by ULVAC, Inc. or the like can be used.

The composite copper particles produced by the above-mentioned method may be appropriately subjected to particle size adjustment by means of a known grinding machine, classifier, or the like.

In the method for producing composite copper particles of the present invention, the average particle diameter of the above-mentioned copper particles is preferably 170 nm or more and 600 nm or less, more preferably 180 nm or more and 500 nm or less, and still more preferably 200 nm or more and 400 nm or less. Such a range is preferable because the composite copper particles of the present invention can efficiently achieve a desired average particle diameter. The above-mentioned copper particles may be commercially available copper particles that are purchased and used, or may be produced by a known method. The copper particles can also be synthesized, for example, by a method comprising the following steps A and B.

### (Step A)

This step is a step of mixing a copper compound, a monocarboxylic acid or a salt thereof, an amine compound, and a solvent. In this step, a mixed solution comprising a copper compound can be obtained.

The above-mentioned copper compound is not particularly limited as long as it comprises a copper atom. Examples of the copper compound comprise copper carboxylates such as copper(I) formate, copper(I) acetate, copper(I) propionate, copper(I) butyrate, copper(I) valerate, copper(I) caproate, copper(I) caprylate, copper(I) caprate, copper(II) formate, copper(II) acetate, copper(II) propionate, copper(II) butyrate, copper(II) valerate, copper(II) caproate, copper(II) caprylate, copper(II) caprate, and copper(II) citrate, copper oxides such as copper(II) oxide and copper(I) oxide, copper hydroxides such as copper(II) hydroxide and copper(I) hydroxide, and copper nitride. Among them, copper(II) oxide is preferable from the viewpoint of cost. These may be used alone or two or more species thereof may be used in combination.

The addition amount of the above-mentioned copper compound is preferably 1 part by mass or more and 100 parts by mass or less with respect to the solvent. It is preferable that the amount of the copper compound is 1 part by mass or more with respect to the solvent from the viewpoint that a decrease in the production amount of the copper particles obtained in step B can be effectively avoided. On the other hand, it is preferable that the amount of the copper compound is 100 parts by mass or less with respect to the solvent from the viewpoint that an uneven reaction caused by thickening when the solvent and the above-mentioned copper compound are mixed in this step can be effectively avoided.

The above-mentioned monocarboxylic acid or a salt thereof used in step A is not particularly limited. The hydrocarbon group in a monocarboxylic acid molecule may be formed only of a single bond or may be formed of one or more multiple bonds in the middle. In addition, a hydrocarbon group moiety in the monocarboxylic acid molecule may be linear, may comprise a branch in the middle, or may comprise a cyclic structure in the middle or at the end. In addition, a heteroatom may be comprised at any position in the monocarboxylic acid molecule.

Examples of the above-mentioned monocarboxylic acid comprise formic acid, acetic acid, propionic acid, butyric acid, valeric acid, caproic acid, caprylic acid, enanthic acid, pelargonic acid, capric acid, lauric acid, oleic acid, stearic acid, and isostearic acid. Examples of the carboxylate comprise an alkali metal salt such as a sodium salt or a potassium salt, an alkaline earth metal salt such as a magnesium salt or a calcium salt, an ammonium salt, and an amine salt.

The above-mentioned monocarboxylic acid or a salt thereof may be only one species or two or more species thereof. In particular, it is preferable to comprise a monocarboxylic acid having 2 or more and 12 or less carbon atoms in one molecule comprising a carboxyl group or a salt thereof, and in particular, it is more preferable to comprise acetic acid, caprylic acid, capric acid, or a salt thereof. The use of such a carboxylic acid or a salt thereof is preferable because the copper particles obtained in step B mentioned later efficiently achieve a desired average particle diameter.

The addition amount of the above-mentioned monocarboxylic acid or a salt thereof is preferably 0.01 mol or more and 2 mol or less with respect to 1 mol of the copper compound. It is preferable that the addition amount of the monocarboxylic acid or a salt thereof is in such a range because the copper particles obtained in step B can efficiently achieve a desired average particle diameter.

The above-mentioned amine compound used in step A is not particularly limited. In particular, an amino alcohol is preferably used. The use of the amino alcohol preferably reduces foaming of the mixed solution comprising the copper compound in step A.

The structure of the amino alcohol is not limited, and examples thereof comprise an alkanol monoamine having one amino group.

Specific examples thereof comprise monoethanolamine, heptaminol, isoethalin, propanolamine, sphingosine, 1-amino-2-propanol, 2-aminodibutanol, 2-diethylaminoethanol, 3-diethylamino-1,2-propanediol, 3-dimethylamino-1,2-propanediol, 3-methylamino-1,2-propanediol, and 3-amino-1,2-propanediol.

The addition amount of the above-mentioned amine compound is preferably 0.25 mol or more and 2 mol or less with respect to 1 mol of the above-mentioned monocarboxylic acid. It is preferable that the addition amount of the amine compound is in such a range from the viewpoint of avoiding thickening of the mixed solution comprising the copper compound.

The addition time of the above-mentioned amine compound is preferably 10 seconds or more and 30 minutes or less. In this way, rapid heat generation of the mixed solution comprising the copper compound in step A is preferably suppressed.

The above-mentioned solvent used in step A is not particularly limited. In particular, an alcohol is preferably used.

Examples of the above-mentioned alcohol comprise 1-propanol, 2-propanol, butanol, pentanol, hexanol, heptanol, and octanol. These may be used alone or two or more species thereof may be used in combination. These alcohols are preferable because they exhibit high compatibility with the following reducing agent.

The mixing order of each of the above-mentioned raw materials is not particularly limited. For example, all the raw materials may be mixed at once, or the solvent and other raw materials may be mixed one by one in an arbitrary order. In particular, it is preferable to mix a solvent, a copper compound, and a monocarboxylic acid or a salt thereof, followed by further mixing with an amine compound.

In the above-mentioned mixing, stirring may be performed by means of a known stirrer, and as such a stirrer, for example, a blade-type stirrer, a disperser mixer, a homomixer, or the like can be used. Also, the mixing time is not particularly limited, but may be 5 minutes or longer. With this mixing time, each of the above-mentioned raw materials can be sufficiently mixed. Furthermore, the rotation speed is also not particularly limited as long as it is 100 rpm or more, and each of the above-mentioned raw materials can be sufficiently mixed at this rotation speed.

### (Step B)

This step is a step of intermittently or continuously adding a reducing agent to the mixed solution comprising the copper compound obtained in step A, and the solution temperature of the above-mentioned mixed solution at the time of addition of the above-mentioned reducing agent is 40° C. or higher and 95° C. or lower. By this step, a dispersion comprising copper particles can be obtained.

The above-mentioned reducing agent is not particularly limited as long as it reduces a copper compound. Furthermore, the boiling point of the reducing agent is preferably 70° C. or higher, and more preferably the heating temperature in the heating step or higher. Use of such a reducing agent is preferable because the copper compound is efficiently reduced even when the solution temperature of the mixed solution is 40° C. or higher and 95° C. or lower.

Examples of the above-mentioned reducing agent comprise hydrazine derivatives. Examples of the hydrazine derivatives comprise hydrazine monohydrate, hydrazine hydrate, methylhydrazine, ethylhydrazine, n-propylhydrazine, i-propylhydrazine, n-butylhydrazine, i-butylhydrazine, sec-butylhydrazine, t-butylhydrazine, n-pentylhydrazine, i-pentylhydrazine, neo-pentylhydrazine, t-pentylhydrazine, n-hexylhydrazine, i-hexylhydrazine, n-heptylhydrazine, n-octylhydrazine, n-nonylhydrazine, n-decylhydrazine, n-undecylhydrazine, n-dodecylhydrazine, cyclohexylhydrazine, phenylhydrazine, 4-methylphenylhydrazine, benzylhydrazine, 2-phenylethylhydrazine, 2-hydrazinoethanol, acetohydrazine, adipic acid dihydrazide, sebacic acid dihydrazide, dodecanediohydrazide, isophthalic acid dihydrazide, and salicylic acid hydrazide. These may be used alone or two or more species thereof may be used in combination.

When the above-mentioned reducing agent is added to the mixed solution comprising the copper compound obtained in step A, the reducing agent is not added at once in a short time, but is intermittently or continuously added. In the present application, “intermittently or continuously adding” or “intermittently or continuously added” means adding or being added little by little over time.

The addition time of the above-mentioned reducing agent is preferably 50 minutes or more and 6 hours or less, and more preferably 60 minutes or more and 6 hours or less. In the present application, the “addition time” refers to a time required from the start point when the reducing agent is added to the mixed solution comprising the copper compound until the total amount of the above-mentioned reducing agent is added to the above-mentioned mixed solution (which is, hereinafter, also referred to as “the time required to add the total amount of the reducing agent”). In addition, the reducing agent may be added in multiple portions within the range of the above-mentioned addition time.

By intermittently or continuously adding the reducing agent, the heat generation caused during reduction can be reduced, and the average particle diameter of the copper particles obtained in this step can be set to a desired range, and therefore, it is preferable that the reducing agent is intermittently or continuously added over a period of 50 minutes or more and 6 hours or less.

The addition amount of the above-mentioned reducing agent is preferably 1.0 mol or more and 4.0 mol or less with respect to 1.0 mol of the above-mentioned copper compound.

In this step, the solution temperature of the mixed solution comprising the copper compound during addition of the above-mentioned reducing agent is preferably 40° C. or higher and 95° C. or lower, and more preferably 45° C. or higher and 90° C. or lower. When the solution temperature of the mixed solution comprising the copper compound is set to the above-mentioned temperature range during addition of the reducing agent, copper particles having a desired average particle diameter can be obtained. The solution temperature of the mixed solution comprising the copper compound may be adjusted before the addition of the reducing agent or during the addition of the reducing agent. Preferably, the solution temperature of the mixed solution comprising the copper compound is adjusted to the above-mentioned range before the addition of the reducing agent.

In this step, a known mixing machine such as a stirrer, a mixer, a homogenizer, or an agitator can be used as necessary. The rotation speed is not limited, but may be 100 rpm or more.

The dispersion comprising copper particles obtained in this step may be aged for several tens of minutes to several hours. The aging temperature is preferably 40° C. or higher and 100° C. or lower, and more preferably 60° C. or higher and 95° C. or lower. The aging time is preferably 5 minutes or more and 2.0 hours or less. Furthermore, during aging, stirring may be performed by means of a known mixing machine mentioned above. The rotation speed is not limited, but may be 100 rpm or more.

The dispersion comprising copper particles obtained in this step may be used as it is in a step of producing composite copper particles, or may be subjected to solid-liquid separation as necessary. In solid-liquid separation, a known filtration method can be used, and for example, a pressure filtration device such as a rotary press or a filter press usually used industrially, or a vacuum filtration device such as a Nutsche filter or a Moore filter can be used. Centrifugation or the like can also be used.

In the solid-liquid separation, the above-mentioned solid content may be washed by a known method.

Further, a step of drying the solid content obtained by the above-mentioned solid-liquid separation may be comprised. When the drying step is comprised, the drying temperature, the drying time, and the drying atmosphere can be appropriately set. For example, the drying temperature is preferably 20° C. or higher and 120° C. or lower, the drying time is preferably 0.5 hours or more and 10 hours or less, and the drying atmosphere is preferably a flow of an inert gas such as nitrogen or argon or a vacuum atmosphere.

In the drying step, for example, a heating device such as a dryer, an oven, or an electric furnace, a desiccator controlled to a predetermined temperature, a vacuum dryer, a decompression dryer, or the like can be used.

When a desiccator is used in the drying step, the above-mentioned solid content can be dried by controlling the inside of the desiccator to a predetermined temperature and creating a vacuum atmosphere. When the inside of the desiccator is brought into a vacuum atmosphere, a vacuum pump may be used. As the vacuum pump, for example, G-20DA manufactured by ULVAC, Inc. or the like can be used.

Copper particles having an average particle diameter of 170 nm or more and 600 nm or less can be obtained by the production method comprising step A and step B mentioned above, and the copper particles obtained here are used as a raw material when the composite copper particles of the present invention are produced.

### <Copper Paste>

The copper paste of the present invention comprises the above-mentioned composite copper particles and a paste solvent.

Examples of the above-mentioned paste solvent comprise ethylene glycol, diethylene glycol, triethylene glycol, polyethylene glycol, propylene glycol, dipropylene glycol, tripropylene glycol, polypropylene glycol, ethylene glycol monobutyl ether, diethylene glycol monobutyl ether, ethylene glycol monohexyl ether, diethylene glycol monohexyl ether, 1,2-propanediol, 1,3-propanediol, and α-terpineol. The above-mentioned paste solvents may be used alone or two or more species thereof may be used in combination.

The copper paste of the present invention can comprise various additives as necessary. Examples of the additive comprise various commonly used reducing agents, dispersants, emulsifiers, antifreezes, pH adjusters, thickeners, deformers, and film-forming agents.

Also, the copper paste of the present invention may comprise copper particles other than the composite copper particles of the present invention. Specifically, micro-copper particles having an average particle diameter of 1 μm to 50 μm or nano-copper particles having an average particle diameter of 100 nm or less may be comprised. The shape of the above-mentioned micro-copper particles and the shape of the nano-copper particles are not particularly limited, and for example, those having any shape such as a spherical shape, a massive shape, a needle shape, a flake shape, a substantially spherical shape, an irregular shape, a polyhedral shape, a spindle shape, and a flat shape, and an agglomeration of these shapes are exemplified. The average particle diameters of the micro-copper particles and the average particle diameters of the nano-copper particles can be measured in the same manner as that used for measuring the average particle diameter of the above-mentioned composite copper particles.

When the copper paste of the present invention comprises the above-mentioned reducing agent, examples of the reducing agent that can be used comprise monoethanolamine, diethanolamine, triethanolamine, dimethylaminoethanol, N-methyldiethanolamine, hydrazine, and formic acid.

The copper paste of the present invention preferably comprises the composite copper particles in an amount of 80 mass % or more and 98 mass % or less, and more preferably 85 mass % or more and 96 mass % or less with respect to the total mass of the paste.

The content of the above-mentioned composite copper particles in an amount of 80 mass % or more is preferable because generation of voids during heating can be reduced, and the bonding strength is further improved. The content thereof in an amount of 98 mass % or less can efficiently reduce agglomeration of the composite copper particles in the paste, and preferably improves the coatability of the paste.

In the mixing step at the time of producing the copper paste of the present invention, a known mixing machine can be used. In addition, in the above-mentioned mixing, defoaming may be performed as necessary.

Examples of the mixing machine comprise a biaxial mixer, a triple roll, a sand mill, and a planetary mixer which are usually used industrially. In addition, in the case of a laboratory scale, a stirrer, a hybrid mixer, a homogenizer, a paint shaker, or the like can be used. At this time, a grinding medium comprising glass, alumina, zirconia, zirconium silicate, or the like as a component may be used as necessary.

### <Bonding Material>

The copper paste of the present invention can be used as a bonding material. The above-mentioned bonding material may appropriately comprise an additive according to its use. According to this bonding material, the base material and the material to be bonded can be preferably bonded.

The above-mentioned base material and the material to be bonded may be the same material or different materials. The above-mentioned material to be bonded is not particularly limited, and examples thereof comprise various metal materials, semiconductor materials (for example, chips), ceramic materials, and resin materials.

Specific examples of the above-mentioned base material comprise a semiconductor substrate such as a silicon substrate, a metal substrate such as a copper substrate, a lead frame, a ceramic substrate attached with a metal plate (for example, Direct Bonded Copper: DBC), a substrate for mounting a semiconductor element such as an LED (Light-Emitting Diode) package, a power supply member such as a copper ribbon, a metal block, and a terminal, a heat dissipation plate, and a water cooling plate.

In the bonding method using the bonding material of the present invention, the bonding material is provided on the base material, and the material to be bonded is placed on a side of the bonding material opposite to the base material to obtain a laminate. The base material and the material to be bonded are bonded by heating the laminate.

Various coating methods such as screen printing, transfer printing, offset printing, letterpress printing, intaglio printing, gravure printing, stencil printing, soft lithography, jet printing, a dispenser, comma coating, slit coating, die coating, gravure coating, bar coating, spray coating, spin coating, and electrodeposition coating can be used as a method of providing a copper paste as a bonding material on a base material.

The bonding material provided on the base material may be appropriately dried. Thereby, the flow of the bonding material and the generation of voids during heating can be reduced. The atmosphere during drying may be an oxygen-free atmosphere, an inert atmosphere, or a reducing atmosphere. The pressure during drying may be atmospheric pressure or reduced pressure. Drying under reduced pressure can promote drying of the bonding material provided on the base material. The temperature during drying may be normal temperature, and heating may be performed as long as the metal particles comprised in the bonding material are not fused.

In particular, the bonding material comprising the copper paste of the present invention can achieve high bondability through sintering by heating alone, and therefore is appropriately used as a pressureless bonding paste.

In the present application, the “pressureless bonding method” refers to a method in which a laminate obtained by disposing the bonding material between the base material and the material to be bonded is prepared, and the above-mentioned laminate is heated in a state where the bonding material and the material to be bonded are disposed in a direction where the weight of the base material acts or in a state where a load of 0.01 MPa or less is applied.

In the present application, the “pressure bonding method” refers to a method in which a laminate obtained by disposing the bonding material between the base material and the material to be bonded is prepared, and the above-mentioned laminate is heated in a state where a load of more than 0.01 MPa is applied.

When the bonding material is sintered by heating, fusion of the metal particles comprised in the bonding material proceeds, so that the base material and the material to be bonded are bonded to form a sintered body.

The heating atmosphere for the laminate in the above-mentioned pressureless bonding method or pressure bonding may be an oxygen-free atmosphere, an inert atmosphere, or a reducing atmosphere, but is more preferably an inert atmosphere from the viewpoint of avoiding an increase in size of the production equipment for the sintered body.

The heating temperature of the laminate in the above-mentioned pressureless bonding method or pressure bonding is preferably 100° C. or higher and 400° C. or lower, and more preferably 150° C. or higher and 300° C. or lower. When the sintering temperature is 300° C. or lower, it can be said that the bonding material of the present invention can be sintered at a sufficiently low temperature.

The heating time of the laminate in the above-mentioned pressureless bonding method or pressure bonding is preferably 1 minute or more and 60 minutes or less from the viewpoint of sufficiently volatilizing the solvent comprised in the bonding material and sufficiently promoting the sintering of the metal particles comprised in the bonding material.

The bonding strength of the sintered body obtained by the above-mentioned pressureless bonding method or pressure bonding is measured by the method described in examples.

The bonding strength of the sintered body obtained by the pressureless bonding method is preferably 20 MPa or more, more preferably 25 MPa or more, and still more preferably 27 MPa or more. A sintered body having such a bonding strength can be determined to be sufficiently bonded, and it can be confirmed that the bonding material of the present invention can be appropriately used for a pressureless bonding paste. As mentioned above, the atmosphere during pressureless bonding is preferably an inert atmosphere, but a sintered body obtained by pressureless bonding in another atmosphere (for example, a reducing atmosphere) can be determined to be sufficiently bonded if the bonding strength of the sintered body is also within the above-mentioned range.

Further, the bonding strength of the sintered body obtained by the pressure bonding method is preferably 20 MPa or more, more preferably 25 MPa or more, and still more preferably 27 MPa or more. A sintered body having such a bonding strength can be determined to be sufficiently bonded, and it can be confirmed that the bonding material of the present invention can be appropriately used for a pressure bonding paste.

### EXAMPLES

The present invention will be described in detail with reference to examples and comparative examples, but the present invention is not limited thereto.

### (Measurement of Average Particle Diameter)

A sample was observed by means of a scanning electron microscope (S4800 manufactured by Hitachi High-Technologies Corporation) to obtain a scanning electron micrograph with a magnification of 50,000 times. With respect to 50 primary particle diameters in the above-mentioned scanning electron micrograph, the Feret diameters were measured, and the arithmetic average value thereof was calculated as the average particle diameter.

### (Measurement of Specific Surface Area)

An operation of mixing 5 g of a sample and 2-propanol (50 ml) and performing solid-liquid separation at a centrifugal force of 400G for 5 minutes by means of a centrifuge (Allegra X-30R manufactured by Beckman Coulter, Inc.) was repeated twice to collect a solid content of copper particles. The collected solid content of copper particles was subjected to preliminary drying under vacuum at 1.3 Pa, 25° C., for 300 minutes to remove the solvent, and then adsorbed moisture was removed by drying in a nitrogen atmosphere to obtain a measurement sample. The specific surface area of the measurement sample was measured under the following conditions by means of a specific surface area measuring apparatus (Macsorb HM Model-1201, manufactured by Mountech Co., Ltd.).

### Drying Conditions

Drying atmosphere: Nitrogen gas (purity: 99.99999%)
Gas flow rate: 50 mL/min
Drying temperature: 80° C.
Drying time: 15 minutes

### Measurement Conditions

Drying atmosphere: mixed gas of 70% helium and 30% nitrogen
Gas flow rate: 25 mL/min
Degassing temperature: 80° C.
Adsorption temperature: −196° C.

### (Identification of Components of Monocarboxylic Acid and Compound Represented by General Formula 1 and Measurement of Content)

A component of a monocarboxylic acid or a salt thereof comprised in a sample and a component of a compound represented by general formula 1: R¹(OCH₂CH₂)ₙOR² (wherein R¹ represents an alkyl group, an aryl group, or a hydrogen atom, R² represents an alkyl group, an aryl group, a hydrogen atom, or an acetyl group, and n is an integer of 1 or more and 4 or less, provided that cases where both R¹ and R² are hydrogen atoms are excluded) were identified and the contents thereof were measured under the following conditions by means of a gas chromatograph-mass spectrometer (Nexis GC-203 manufactured by Shimadzu Corporation) equipped with Multi-Shot Pyrolyzer (MODEL EGA/PY-3030D manufactured by Frontier Laboratories, Ltd.).

### Multi-Shot Pyrolyzer

Heating furnace temperature: 300° C.
Sample amount: 5 mg

### Gas Chromatograph-Mass Spectrometer

Column temperature: held at 60° C. for 3 minutes, then increased and held at 220° C. for 5 minutes
Heating speed: 25° C./min
Separation column: Ultra ALLOY-1 (product number: UA-15W-5.0F, manufactured by Frontier Laboratories, Ltd.)
Column flow rate: nitrogen (99.999% UP) 6 mL/min

### Detector (Hydrogen Flame Ionization Detector: FID)

Detector temperature: 320° C.
Hydrogen flow rate: 30 mL/min
Air flow rate: 300 mL/min

### (Calculation of Molecular Density)

The molecular density (molecules/nm²) of the monocarboxylic acid component with respect to 1 nm² of the surface area of the sample was calculated by the following formula.

$$[ Number of molecules of monocarboxylic acid component ] = {M}_{acid} / ( {M}_{w} / {N}_{A} )$$

Here, the number of molecules of the monocarboxylic acid component is expressed as follows.

$$[ Molecular density ] = number of molecules of monocarboxylic acid component / specific surface area of copper particle$$

M_{acid} is the content (g) of the monocarboxylic acid or a salt thereof comprised in 1 g of the sample, M_{w} is the molecular weight (g/mol) of the monocarboxylic acid component, and N_{A} is the Avogadro constant (that is, 6.02×10²³ mol⁻¹).

### (Production of Bonding Material)

A sample and a paste solvent were mixed at a ratio shown in Tables 1 to 3 below, and the mixture was kneaded for 4 minutes by means of a mixer (Awatori Rentaro AR-250, manufactured by Thinky Corporation), and this was repeated twice to obtain a bonding material.

### (Measurement of Bonding Strength)

On a base material having a diameter (which is, hereinafter, denoted as @) of 10 mm and a thickness of 5 mm, a metal mask having an opening with a @ of 5 mm and a thickness of 0.1 mm was placed, and the bonding material was applied to the opening. A copper piece having a @ of 5 mm, a thickness of 5 mm, and a surface roughness (Ra: arithmetic average roughness) of 0.1 to 0.2 μm was allowed to stand on the portion where the bonding material was applied to obtain a laminate. The above-mentioned surface roughness was determined as the average value of Ra measured with a laser microscope for 3 test pieces randomly taken out among 100 test pieces.

Nitrogen (purity: 99.995%) was allowed to flow at 100 mL/min, and the above-mentioned laminate was allowed to stand on a hot plate heated to 200° C. and held for 30 minutes. Thereafter, the resultant was naturally cooled to 50° C. to obtain a sintered body.

The above-mentioned sintered body was set in a strength tester (JSL-1KN manufactured by Japan Instrumentation System Co., Ltd.), a shearing force was applied in a direction parallel to the bonding surface under a condition of 1 mm/sec from the base material side, and the bonding strength was calculated from the load applied at the time when the base material and the copper piece were peeled off.

### Production Example 1

A 10 L four-neck glass flask was placed in an oil bath, 2 L of 1-propanol (manufactured by Kishida Chemical Co., Ltd.) as a solvent, 637.6 g of copper(II) oxide (N-300 manufactured by Nisshin Chemco Ltd.), 96 g of acetic acid (manufactured by FUJIFILM Wako Pure Chemical Corporation), and 82.7 g of capric acid (manufactured by FUJIFILM Wako Pure Chemical Corporation) were added thereto, and the mixture was stirred at room temperature under the condition of a rotation speed of 250 rpm.

Furthermore, 127.0 g of 2-aminoethanol (manufactured by Tokyo Chemical Industry Co., Ltd.) was added over 10 minutes, and stirring was continued to prepare a mixed solution comprising the above-mentioned copper compound. The rotation speed for the subsequent stirring was set to 250 rpm.

The mixed solution comprising the copper compound was heated to a solution temperature of 50° C., and 160 g of 60% hydrazine hydrate (manufactured by Mitsubishi Gas Chemical Company, Inc.) as a reducing agent was added dropwise thereto over 7 minutes and 30 seconds, and the resulting mixture was stirred for 40 minutes. Thereto 160 g of 60% hydrazine hydrate was added dropwise over 7 minutes and 30 seconds, and the resulting mixture was stirred for 15 minutes. Thereto 680 g of 60% hydrazine hydrate was added dropwise over 30 minutes, then the temperature was raised to 90° C., and the resulting mixture was stirred for 2 hours to obtain a dispersion comprising copper particles. The time required to add the total amount of the reducing agent was 100 minutes, and the set temperature of the oil bath during the addition of the reducing agent was set to 50° C.

The dispersion comprising the above-mentioned copper particles was naturally cooled to 50° C. or lower, and then allowed to stand for 30 minutes to perform solid-liquid separation, and 30 g of a solid content was weighed out and collected. The above-mentioned solid content was mixed with 75 mL of 2-propanol (manufactured by NACALAI TESQUE, INC.), followed by stirring for 10 minutes. Thereafter, solid-liquid separation was performed at a centrifugal force of 400G for 5 minutes by means of a centrifuge (Allegra X-30R manufactured by Beckman Coulter, Inc.) to obtain a solid content of copper particles of Production Example 1.

### Production Example 2

A solid content of copper particles of Production Example 2 was obtained in the same manner as in Production Example 1 except that the condition for adding the reducing agent dropwise in Production Example 1 was changed to the following condition.

The above-mentioned mixed solution was heated to a solution temperature of 50° C., 80 g of 60% hydrazine hydrate (manufactured by Mitsubishi Gas Chemical Company, Inc.) as a reducing agent was added dropwise thereto over 3 minutes and 45 seconds, and the resulting mixture was stirred for 60 minutes. Thereto 80 g of 60% hydrazine hydrate was added dropwise over 3 minutes and 45 seconds, and the resulting mixture was stirred for 40 minutes. Thereto 80 g of 60% hydrazine hydrate was added dropwise over 3 minutes and 45 seconds, and the resulting mixture was stirred for 40 minutes. Thereto 80 g of 60% hydrazine hydrate was added dropwise over 3 minutes and 45 seconds, and the resulting mixture was stirred for 40 minutes. Thereto 680 g of 60% hydrazine hydrate was added dropwise over 30 minutes, then the temperature was raised to 90° C., and the resulting mixture was stirred for 2 hours to obtain a dispersion comprising copper particles. The time required to add the total amount of the reducing agent was 225 minutes, and the set temperature of the oil bath during the addition of the reducing agent was set to 50° C.

### Production Example 3

A 10 L four-neck glass flask was placed in an oil bath, 2 L of 1-propanol (manufactured by Kishida Chemical Co., Ltd.) as a solvent, 637.6 g of copper(II) oxide (N-300 manufactured by Nisshin Chemco Ltd.), 96 g of acetic acid (manufactured by FUJIFILM Wako Pure Chemical Corporation), and 82.7 g of capric acid (manufactured by FUJIFILM Wako Pure Chemical Corporation) were added thereto, and the mixture was stirred at room temperature under the condition of a rotation speed of 250 rpm.

Furthermore, 127.0 g of 2-aminoethanol (manufactured by Tokyo Chemical Industry Co., Ltd.) was added over 10 minutes, and stirring was continued to prepare a mixed solution comprising the copper compound. The rotation speed for the subsequent stirring was set to 250 rpm.

The mixed solution comprising the above-mentioned copper compound was heated to a solution temperature of 90° C., and 996 g of 60% hydrazine hydrate (manufactured by Mitsubishi Gas Chemical Company, Inc.) as a reducing agent was added dropwise over 300 minutes, and the resulting mixture was stirred for 10 minutes while being maintained at 90° C. to obtain a dispersion of copper particles.

The dispersion comprising the above-mentioned copper particles was naturally cooled to 50° C. or lower, and then allowed to stand for 30 minutes to perform solid-liquid separation, and 30 g of a solid content was weighed out and collected. The above-mentioned solid content was mixed with 75 mL of 2-propanol (manufactured by NACALAI TESQUE, INC.), followed by stirring for 10 minutes. Thereafter, solid-liquid separation was performed at a centrifugal force of 400G for 5 minutes by means of a centrifuge (Allegra X-30R manufactured by Beckman Coulter, Inc.) to obtain a solid content of copper particles of Production Example 3.

### Production Example 4

A solid content of copper particles of Production Example 4 was obtained in the same manner as in Production Example 1 except that the weight of each raw material in Production Example 1 was halved and the condition for adding the reducing agent dropwise in Production Example 1 was changed to dropwise addition over 45 minutes.

### Example 1

Caprylic acid (manufactured by FUJIFILM Wako Pure Chemical Corporation), diethylene glycol monohexyl ether (DGMHE (manufactured by Tokyo Chemical Industry Co., Ltd.)), and 2-propanol were stirred so that the amount of caprylic acid was 6 mass % and the amount of DGMHE was 6 mass % with respect to 2-propanol to prepare 75 mL of a treatment solution.

The solid content of the copper particles of Production Example 1 and the above-mentioned treatment solution were mixed, followed by stirring for 10 minutes to perform a surface treatment on the copper particles of Production Example 1. Thereafter, an operation of solid-liquid separation was performed at a centrifugal force of 400G for 5 minutes by means of a centrifuge (Allegra X-30R manufactured by Beckman Coulter, Inc.). This operation was repeated twice to collect the solid content.

The obtained solid content was allowed to stand in a desiccator, the inside of the desiccator was depressurized by a vacuum pump (G-20DA manufactured by ULVAC, Inc.), and vacuum-dried at 1.3 Pa and 25° C. for 300 minutes to obtain sample 1.

### Example 2

Sample 2 was obtained in the same manner as in Example 1 except that DGMHE used in Example 1 was changed to diethylene glycol monobutyl ether (DGMBE (manufactured by Tokyo Chemical Industry Co., Ltd.)).

### Example 3

Sample 3 was obtained in the same manner as in Example 1 except that the amount of caprylic acid used in Example 1 was changed from 6 mass % to 15 mass % and the amount of DGMHE used in Example 1 was changed from 6 mass % to 15 mass %.

### Example 4

Sample 4 was obtained in the same manner as in Example 1 except that the amount of caprylic acid used in Example 1 was changed from 6 mass % to 3 mass % and the amount of DGMHE used in Example 1 was changed from 6 mass % to 3 mass %.

### Example 5

Sample 5 was obtained in the same manner as in Example 1 except that caprylic acid used in Example 4 was changed to capric acid (manufactured by FUJIFILM Wako Pure Chemical Corporation).

### Example 6

Sample 6 was obtained in the same manner as in Example 1 except that the copper particles used in Example 1 were those produced in Production Example 2.

### Example 7

Sample 7 was obtained in the same manner as in Example 1 except that the copper particles used in Example 1 were those produced in Production Example 3.

### Example 8

Sample 8 was obtained in the same manner as in Example 1 except that the copper particles used in Example 1 were those produced in Production Example 2 and caprylic acid in the treatment solution used in Example 1 was changed to 2-ethylcaproic acid (manufactured by Tokyo Chemical Industry Co., Ltd.).

### Comparative Example 1

Sample 9 was obtained in the same manner as in Example 1 except that the treatment solution did not comprise DGMHE used in Example 1 as the compound represented by the above-mentioned general formula 1.

### Comparative Example 2

Sample 10 was obtained in the same manner as in Example 1 except that the treatment solution did not comprise caprylic acid used in Example 1 as the carboxylic acid or a salt thereof.

### Comparative Example 3

Sample 11 was obtained in the same manner as in Example 4 except that the copper particles used in Example 4 were those produced in Production Example 4.

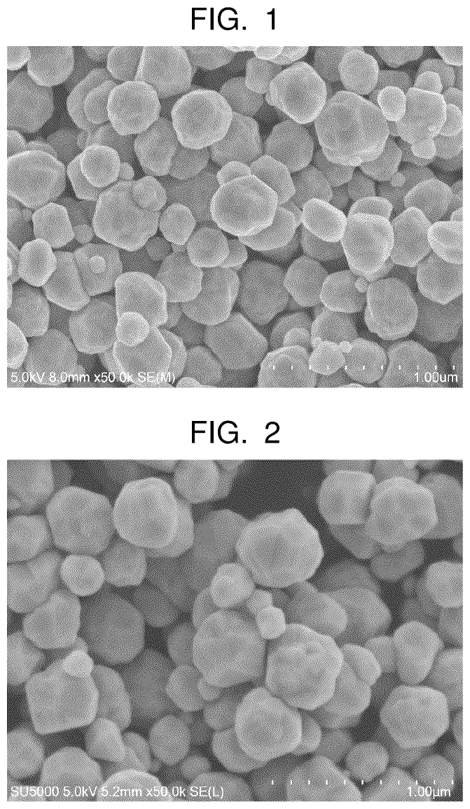

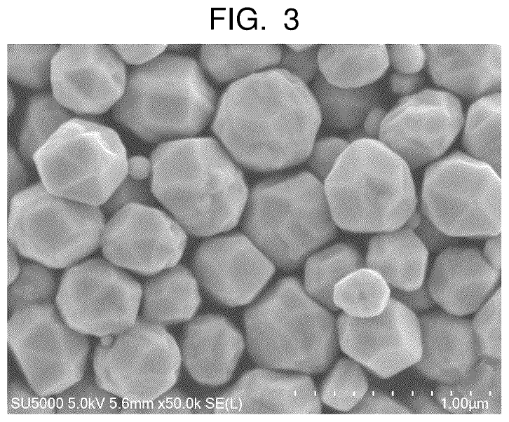

Regarding Samples 1 to 11, the average particle diameter, the species and content of the monocarboxylic acid component, the content of the compound represented by general formula 1: R¹(OCH₂CH₂)ₙOR² (wherein R¹ represents an alkyl group, an aryl group, or a hydrogen atom; R² represents an alkyl group, an aryl group, a hydrogen atom, or an acetyl group; and n is an integer of 1 or more and 4 or less; provided that R¹ and R² are not both hydrogen atoms), and the bonding strength of the sintered body were evaluated according to the above-mentioned methods. The results are shown in Tables 1 to 3 (in the tables, the compound represented by the above-mentioned general formula 1 is simply referred to as “Compound of general formula 1”). Further, scanning electron micrographs of Samples 1, 6, and 7 are shown in FIGS. 1 to 3.

TABLE 1

| | Average | Monocarboxylic acid | | | Compound of | | |
|---|---|---|---|---|---|---|---|
| | Particle | | | Molecular | general formula 1 | | Bonding |
| | Diameter | | Content | density | | Content | Strength |
| Sample | (nm) | Species | (mass %) | (molecules/nm²) | Species | (mass %) | (MPa)*¹ |
| 1 | 210 | Caprylic | 0.50 | 10.27 | DGMHE | 0.45 | 27.3 |
| | | acid | | | | | |
| 2 | 210 | Caprylic | 0.57 | 11.76 | DGMBE | 0.45 | 24.4 |
| | | acid | | | | | |
| 3 | 210 | Caprylic | 1.48 | 30.41 | DGMHE | 1.38 | 39.9 |
| | | acid | | | | | |
| 4 | 210 | Caprylic | 0.33 | 6.72 | DGMHE | 0.21 | 29.2 |
| | | acid | | | | | |
| 5 | 210 | Capric | 0.55 | 11.30 | DGMHE | 0.20 | 51.0 |
| | | acid | | | | | |
| 6 | 298 | Caprylic | 0.46 | 10.93 | DGMHE | 0.37 | 21.8 |
| | | acid | | | | | |
| 9 | 210 | Caprylic | 0.56 | 11.40 | — | — | 3.1 |
| | | acid | | | | | |
| 10 | 210 | — | — | — | DGMHE | 0.52 | 8.4 |
| 11 | 155 | Caprylic | 0.53 | 8.88 | DGMHE | 0.36 | 11.0 |
| | | acid | | | | | |

*¹Samples 1 to 6 and Samples 9 to 11 were each blended with 88 mass % of the sample, 11.4 mass % of dipropylene glycol, and 0.6 mass % of triethanolamine.

TABLE 2

| | Average | Monocarboxylic acid | | | Compound of | | |
|---|---|---|---|---|---|---|---|
| | Particle | | | Molecular | general formula 1 | | Bonding |
| | Diameter | | Content | density | | Content | Strength |
| Sample | (nm) | Species | (mass %) | (molecules/nm²) | Species | (mass %) | (MPa)*² |
| 1 | 210 | Caprylic | 0.50 | 10.27 | DGMHE | 0.45 | 51.0 |
| | | acid | | | | | |
| 7 | 363 | Caprylic | 0.42 | 10.96 | DGMHE | 0.38 | 36.8 |
| | | acid | | | | | |
| 8 | 298 | 2- | 0.50 | 11.54 | DGMHE | 0.46 | 35.4 |
| | | Ethylcaproic | | | | | |
| | | acid | | | | | |

*²Samples 1, 7 and 8 were each blended with 92.5 mass % of the sample, 3.6 mass % of dipropylene glycol, 3.6 mass % of diethylene glycol monohexyl ether, and 0.3 mass % of triethanolamine.

TABLE 3

| | Average | Monocarboxylic acid | | | Compound of | | |
|---|---|---|---|---|---|---|---|
| | Particle | | | Molecular | general formula 1 | | Bonding |
| | Diameter | | Content | density | | Content | Strength |
| Sample | (nm) | Species | (mass %) | (molecules/nm²) | Species | (mass %) | (MPa)*³ |
| 6 | 298 | Caprylic | 0.46 | 10.93 | DGMHE | 0.37 | 35.1 |
| | | acid | | | | | |

*³Sample 6 was blended with 92.5 mass % of the sample and 7.5 mass % of α-terpineol.

The composite copper particles of Samples 1 to 8 comprise a monocarboxylic acid and a compound represented by the above-mentioned general formula 1, and have an average particle diameter of 170 nm or more. It was confirmed that sintered bodies obtained by the use of these samples as bonding materials have a sufficient bonding strength (20 MPa or more). From this, it can be said that the composite copper particles of the present invention can be sintered even in an inert atmosphere, and can be appropriately used for a bonding material in a pressureless bonding method.

On the other hand, Samples 9 and 10 have an average particle diameter of 170 nm or more, but do not comprise a monocarboxylic acid or a compound represented by the above-mentioned general formula 1. Sample 11 comprised a monocarboxylic acid and a compound represented by the above-mentioned general formula 1, but had an average particle diameter of less than 170 nm. It was confirmed that a sintered body obtained by the use of such a sample as a bonding material has an insufficient bonding strength (less than 20 MPa).

### INDUSTRIAL APPLICABILITY

The composite copper particles of the present invention can be easily produced without any restriction at the time of the production. In addition, a copper paste comprising the obtained composite copper particles can also be produced. The bonding material comprising the copper paste exhibits excellent bonding characteristics even under the conditions of the pressureless bonding method, and a sintered body having a sufficient bonding strength can be obtained by the use of the copper paste of the present invention for the bonding material.

1. Composite copper particles comprising:
copper particles;
a monocarboxylic acid or a salt thereof; and
a compound represented by general formula 1: R¹(OCH₂CH₂)ₙOR²,
wherein R¹ represents an alkyl group, an aryl group, or a hydrogen atom;
R² represents an alkyl group, an aryl group, a hydrogen atom, or an acetyl group; and
n is an integer of 1 or more and 4 or less; provided that R¹ and R² are not both hydrogen atoms,
wherein an average particle diameter measured by means of a scanning electron microscope is 170 nm or more and 600 nm or less.

2. The composite copper particles according to claim 1 comprising the monocarboxylic acid or the salt thereof in an amount of 5.3 molecules or more and 50.0 molecules or less with respect to 1 nm² of a surface area of the copper particles.

3. The composite copper particles according to claim 1, wherein the monocarboxylic acid or the salt thereof has 2 or more and 12 or less carbon atoms.

4. The composite copper particles according to claim 1, wherein the monocarboxylic acid or the salt thereof is at least one carboxylic acid selected from the group consisting of caprylic acid, capric acid, and 2-ethylcaproic acid, or a salt thereof.

5. The composite copper particles according to claim 1, wherein the monocarboxylic acid or the salt thereof is at least one carboxylic acid selected from the group consisting of caprylic acid and capric acid, or a salt thereof.

6. The composite copper particles according to claim 1, wherein a molecular weight of the compound represented by general formula 1 is 100 or more and 400 or less.

7. The composite copper particles according to claim 1, wherein the compound represented by general formula 1 is diethylene glycol monohexyl ether or diethylene glycol monobutyl ether.

8. The composite copper particles according to claim 1, wherein a content of the compound represented by general formula 1 is 0.1 mass % or more and 2.0 mass % or less with respect to a total mass of the composite copper particles.

9. The composite copper particles according to claim 1, wherein a total mass of the monocarboxylic acid or the salt thereof and the compound represented by general formula 1 is 0.3 mass % or more and 3.5 mass % or less with respect to a total mass of the composite copper particles.

10. A method for producing composite copper particles having an average particle diameter of 170 nm or more and 600 nm or less measured by means of a scanning electron microscope, the method comprising a step of mixing copper particles, a monocarboxylic acid or a salt thereof, a compound represented by general formula 1: R¹(OCH₂CH₂)ₙOR², wherein R¹ represents an alkyl group, an aryl group, or a hydrogen atom; R² represents an alkyl group, an aryl group, a hydrogen atom, or an acetyl group; and n is an integer of 1 or more and 4 or less; provided that R¹ and R² are not both hydrogen atoms, and a solvent.

11. The method according to claim 10, wherein the monocarboxylic acid or the salt thereof has 2 or more and 12 or less carbon atoms.

12. The method according to claim 10, wherein the monocarboxylic acid or the salt thereof is at least one carboxylic acid selected from the group consisting of caprylic acid, capric acid, and 2-ethylcaproic acid, or a salt thereof.

13. The method according to claim 10, wherein the monocarboxylic acid or the salt thereof is at least one carboxylic acid selected from the group consisting of caprylic acid and capric acid, or a salt thereof.

14. The method according to claim 10, wherein a molecular weight of the compound represented by general formula 1 is 100 or more and 400 or less.

15. The method according to claim 10, wherein the compound represented by general formula 1 is diethylene glycol monohexyl ether or diethylene glycol monobutyl ether.

16. The method according to claim 10, wherein the monocarboxylic acid or the salt thereof is mixed in an amount of 1 mass % or more and 30 mass % or less with respect to the solvent.

17. The method according to claim 10 comprising the monocarboxylic acid or the salt thereof in the solvent in an amount of 1 mass % or more and 30 mass % or less with respect to the solvent.

18. The method according to claim 10, wherein the compound represented by general formula 1 is mixed in an amount of 1 mass % or more and 30 mass % or less with respect to the solvent.

19. The method according to claim 10 comprising the compound represented by general formula 1 in the solvent in an amount of 1 mass % or more and 30 mass % or less with respect to the solvent.

20. The method according to claim 10, wherein the monocarboxylic acid or the salt thereof and the compound represented by general formula 1 are mixed in a total mass of 2 mass % or more and 35 mass % or less with respect to the solvent.

21. The method according to claim 10 comprising the monocarboxylic acid or the salt thereof and the compound represented by general formula 1 in the solvent in a total mass of 2 mass % or more and 35 mass % or less with respect to the solvent.

22. A copper paste comprising the composite copper particles according to claim 1 and a paste solvent.

23. A bonding material comprising the copper paste according to claim 22.
